(19) United States
(12) Patent Application Publication
(10) Pub. No.: US 2009/0231997 A1
(43) Pub. Date: Sep. 17, 2009

(54) METHOD FOR DISPLAYING A PACKET SWITCHED CONGESTION STATUS OF A WIRELESS COMMUNICATION NETWORK

(75) Inventors: Bin Yang, Beijing (CN); Hong-Bin Liang, Chengdu (CN); Yong Liu, Beijing (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/395,783

(22) Filed: Mar. 2, 2009

(30) Foreign Application Priority Data
Mar. 14, 2008 (CN) 200810086536.4

(51) Int. Cl. G08C 15/00

(52) U.S. Cl. 370/229

(57) ABSTRACT

A method and mobile electronic device are provided that display, for a user, a packet switched congestion status of a wireless communication network that is useful for estimating a network quality of service. The method includes transmitting a packet switched congestion status inquiry message from the mobile electronic device to a first network element in the wireless communication network. A reply message received from the first network element in response to the packet switched congestion status inquiry message is then processed. The reply message includes transmission delay information obtained from a device transmission delay between the first network element and the mobile electronic device and a network transmission delay between the first network element and at least one packet switched support node. The packet switched congestion status is then determined based on the transmission delay information. Finally, the packet switched congestion status is displayed on the mobile electronic device.

### FIELD OF THE INVENTION

The present invention relates generally to handheld electronic devices and in particular, although not exclusively, to displaying on a display screen of an electronic device a packet switched congestion status of a wireless communication network.

### BACKGROUND

Many wireless communication services now support both circuit switched (CS) communications and packet switched (PS) communications. For example, the General Packet Radio Service (GPRS) is incorporated into existing circuit-switched Global System for Mobile (GSM) networks. PS communications are becoming increasingly popular and are used, for example, for facsimile services, messaging, internet access, data uploads and downloads, and voice communications using voice over internet protocol (VOIP).

Packet-switched data communications are based on specific protocol procedures. For example, the Third Generation Partnership Project (3GPP) technical specifications define PS Core Network (CN) services for GSM and Universal Mobile Telecommunications System (UMTS) networks. The CN services employ a Packet Data Protocol (PDP) to route Protocol Data Units (PDUs) through a network based on factors such as a required Quality of Service (QoS). Each mobile station operating in a network then uses a specific PDP context that includes mapping and routing information for transferring PDP PDU's between the mobile station and another network node such as a Gateway General Packet Radio Service (GPRS) Support Node (GGSN). PDP contexts thus can be activated, modified and deactivated by a mobile station based on the mobile station's immediate need for network resources. However, the quality and speed of PS communication services can be significantly reduced when a PS services network is congested. Thus users may prefer to use PS communication services during periods of light network congestion. For example, during periods of light network congestion downloading and uploading files can require less time, VOIP calls can be clearer, and internet access can be faster.

### BRIEF DESCRIPTION OF THE DRAWINGS

In order that the invention may be readily understood and put into practical effect, reference now will be made to exemplary embodiments as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating an electronic device in the form of a mobile telephone, according to some embodiments of the present invention;

FIG. 2 is a diagram illustrating a wireless communication network comprising a circuit switched (CS) network, a packet switched (PS) network, and the mobile telephone of FIG. 1, according to some embodiments of the present invention;

FIG. 3 is a message sequence chart illustrating an exchange of messages in the wireless communication network shown in FIG. 2, according to some embodiments of the present invention;

FIG. 4 is a series of three images of an embodiment of the mobile telephone of FIG. 1, where each image includes a different PS traffic status icon displayed on a display screen, according to some embodiments of the present invention; and

FIG. 5 is a flow diagram illustrating a method for displaying on an electronic device a packet switched congestion status of a wireless communication network, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and device components related to displaying on an electronic device a packet switched congestion status of a wireless communication network. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, front and back, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device. An element preceded by “comprises a . . . ” does not, without more constraints, preclude the existence of additional identical elements in the process, method, article, or apparatus that comprises the element.

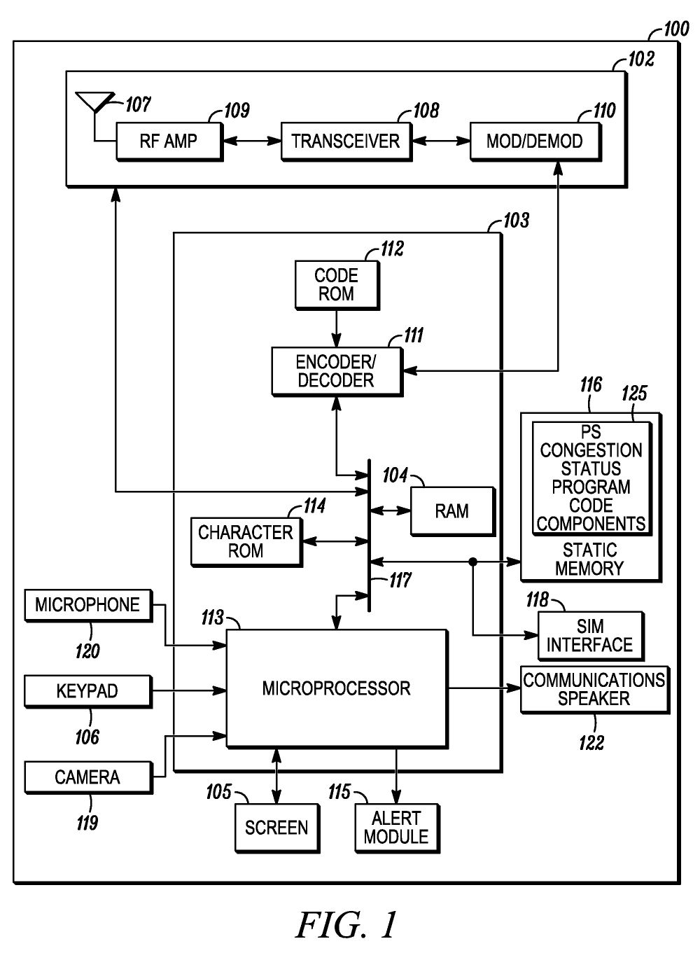

Referring to FIG. 1, a schematic diagram illustrates an electronic device in the form of a mobile telephone 100, according to some embodiments of the present invention. The mobile telephone 100 comprises a radio frequency communications unit 102 coupled to be in communication with a common data and address bus 117 of a processor 103. The mobile telephone 100 also has a keypad 106 and a display screen 105, such as a touch screen coupled to be in communication with the processor 103.

The processor 103 also includes an encoder/decoder 111 with an associated code Read Only Memory (ROM) 112 for storing data for encoding and decoding voice or other signals that may be transmitted or received by the mobile telephone 100. The processor 103 further includes a microprocessor 113 coupled, by the common data and address bus 117, to the encoder/decoder 111, a character Read Only Memory (ROM) 114, a Random Access Memory (RAM) 104, programmable memory 116, a Subscriber Identity Module (SIM) interface 118, and a camera 119. The programmable memory 116 and a SIM operatively coupled to the SIM interface 118 each can store, among other things, a telephone number database (TND) comprising a number field for telephone numbers and a name field for identifiers uniquely associated with the telephone numbers in the number field.

The radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that is coupled to the encoder/decoder 111.

The microprocessor 113 has ports for coupling to the keypad 106 and to the display screen 105. The microprocessor 113 further has ports for coupling to an alert module 115 that typically contains an alert speaker, vibrator motor and associated drivers; to a microphone 120; and to a communications speaker 122. The character ROM 114 stores code for decoding or encoding data such as control channel messages that may be transmitted or received by the communications unit 102. In some embodiments of the present invention, the character ROM 114, the programmable memory 116, or a SIM also can store operating code (OC) for the microprocessor 113 and code for performing functions associated with the mobile telephone 100. For example, the programmable memory 116 can comprise packet switched (PS) congestion status program code components 125 configured to cause execution of a method for displaying on the display screen 105 a PS congestion status of a wireless communication network.

Thus some embodiments of the present invention include a method for displaying on an electronic device such as the mobile telephone 100 a packet switched congestion status of a wireless communication network. The method includes transmitting a packet switched congestion status inquiry message from the electronic device to a first network element in the wireless communication network. A reply message received from the first network element in response to the packet switched congestion status inquiry message is then processed. The reply message includes transmission delay information obtained from a device transmission delay between the first network element and the electronic device and a network transmission delay between the first network element and at least one packet switched support node in the wireless communication network. The packet switched congestion status of the wireless communication network is then determined based on the transmission delay information. Finally, the packet switched congestion status is displayed on a display screen of the electronic device.

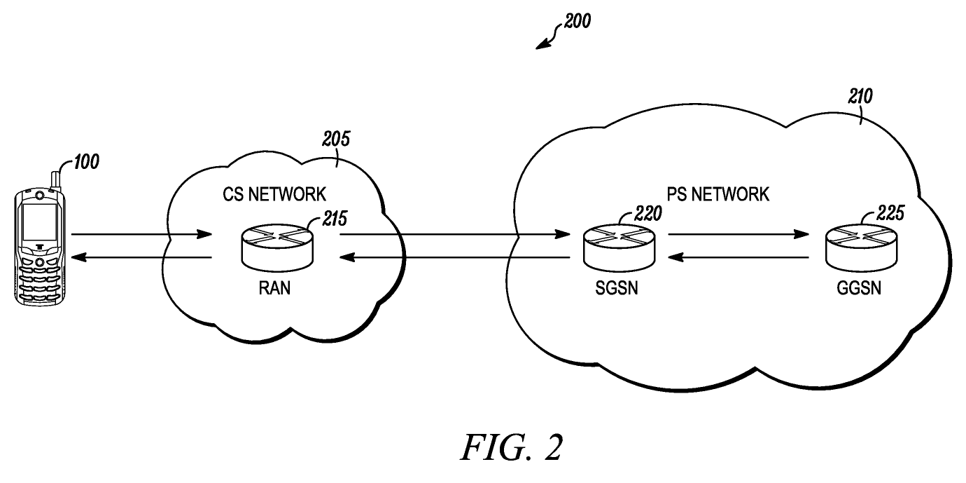

Referring to FIG. 2, a diagram illustrates a wireless communication network 200 comprising a circuit switched (CS) network 205, a packet switched (PS) network 210, and the mobile telephone 100, according to some embodiments of the present invention. Consider that the mobile telephone 100 executes PS communication services through the wireless communication network 200. To do so, the mobile telephone 100 first establishes communications with a radio access network (RAN) 215 in the CS network 205. The RAN 215 then communicates with a serving general packet radio service support node (SGSN) 220 in the PS network 210. Next, the SGSN 220 communicates with a gateway general packet radio service support node (GGSN) 225. Finally, the GGSN 225 contacts another network element (not shown) that is in operative communication with a callee device (not shown). PS data can then flow back and forth between the mobile telephone 100 and the GGSN 225.

As described above, the quality and speed of PS communication services can be significantly reduced when a PS services network is congested. For example, if the PS network 210 is processing a large amount of PS data traffic, a quality of service (QoS) between the PS network 210 and the CS network 205 can degrade. Thus a user of the mobile telephone 100 may prefer to use PS communication services during periods of light network congestion. However, according to the prior art, there is not a convenient way for a user to become aware of a packet switched congestion status of a network.

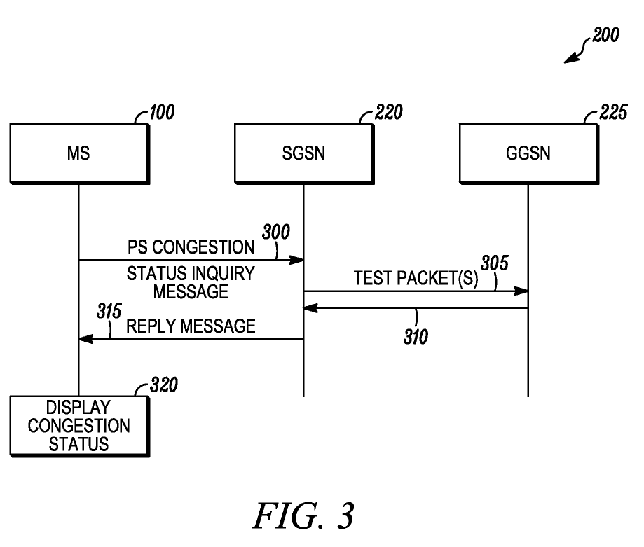

Referring to FIG. 3, a message sequence chart illustrates an exchange of messages in the wireless communication network 200, according to some embodiments of the present invention. At line 300, a PS congestion status inquiry message is transmitted from a mobile station (MS) such as the mobile telephone 100 to the SGSN 220. For example, such a message may be only a single frame transmitted through the RAN 215. There are many types of prior art interactions that occur between mobile telephones and SGSNs such as, for example, Attach messages and periodic radio access (RA) update messages. Thus a PS congestion status inquiry message according to the present invention can, for example, be incorporated into or based on such messages.

At line 305, in response to the PS congestion status inquiry message, an initial test packet including, for example, sample packet data, is transmitted from the SGSN 220 to the GGSN 225. Then, at line 310, at least one return test packet is transmitted from the GGSN 225 to the SGSN 220 in response to the initial test packet. The time at which the return test packet arrives at the SGSN 220 enables the SGSN 220 to calculate a total round trip time between the SGSN 220 and the GGSN 225. For example, a time of arrival of the return test packet can be simply subtracted from a time of transmission of the initial test packet to calculate a total round trip time. The total round trip time thus can provide a benchmark for a current network transmission delay based on current network operating conditions, including network congestion, of the PS network 210.

At line 315, a reply message is then transmitted from the SGSN 220 to the mobile telephone 100. The reply message includes transmission delay information concerning PS communications in the wireless communication network 200. For example, the reply message can include an information element (IE) that includes the total round trip time between the SGSN 220 and the GGSN 225, and a sent time indicating when the reply message was sent. The mobile telephone 100 then can calculate a total delay time between the mobile telephone 100 and the GGSN 225 by subtracting the sent time of the reply message from a time of receipt of the reply message by the mobile telephone 100, and adding half of the round trip time between the SGSN 220 and the GGSN 225.

At block 320, the total delay time is used by the mobile telephone 100 to determine a PS congestion status of the wireless communication network 200. Finally, the congestion status is displayed on the display screen 105 of the mobile telephone 100 using, for example, a congestion status icon.

The total delay time can be converted to a congestion status in various ways, as will be understood by those having ordinary skill in the art. For example, the total delay time can be compared to established benchmark delay times established by operators of the wireless communication network 200. Alternatively, the total delay time can be compared with average, maximum and minimum delay times observed by the mobile telephone 100 during previous operating periods, for example delay times observed during previous days, weeks or months, and recorded in the programmable memory 116 of the mobile telephone 100.

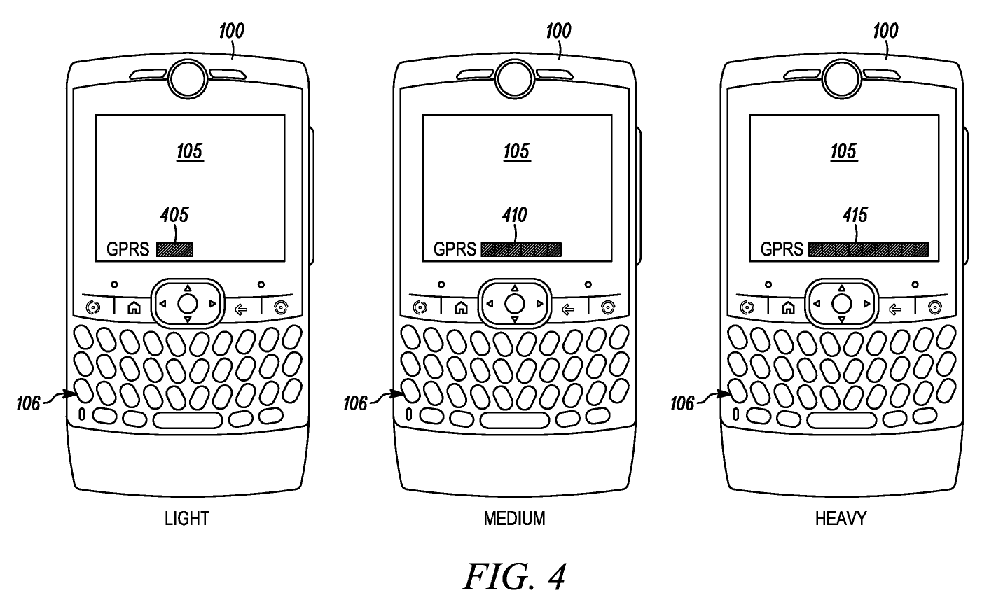

Referring to FIG. 4, a series of three images are provided of an embodiment of the mobile telephone 100, where each image includes a different PS traffic status icon displayed on the display screen 105, according to some embodiments of the present invention. A first PS traffic status icon 405 corresponds with a light amount of PS traffic congestion in the wireless communication network 200. The first PS traffic status icon 405 is shown as a short length bar along a lower edge of the display screen 105, and may be a color-coded status icon using the color green to indicate that a light amount of PS traffic congestion likely corresponds with faster and higher quality PS communications.

A second PS traffic status icon 410 corresponds with a medium amount of PS traffic congestion in the wireless communication network 200. The second PS traffic status icon 410 is shown as a medium length bar along a lower edge of the display screen 105, and may be a color-coded status icon using the color orange to indicate that a medium amount of PS traffic congestion likely corresponds with average speed and average quality PS communications.

A third PS traffic status icon 415 corresponds with a heavy amount of PS traffic congestion in the wireless communication network 200. The third PS traffic status icon 415 is shown as a long length bar along a lower edge of the display screen 105, and may be a color-coded status icon using the color red to indicate that a heavy amount of PS traffic congestion likely corresponds with slower and lower quality PS communications.

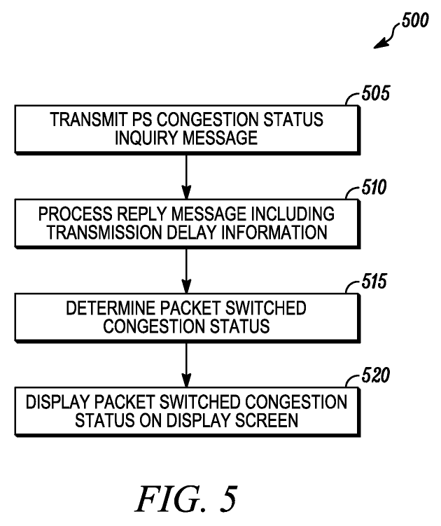

Referring to FIG. 5, a flow diagram illustrates a method 500 for displaying on an electronic device a packet switched congestion status of a wireless communication network, according to some embodiments of the present invention. At step 505, a packet switched congestion status inquiry message is transmitted from the electronic device to a first network element in the wireless communication network. For example, in the wireless communication network 200, as shown at line 300 of FIG. 3, a PS congestion status inquiry message is transmitted from the mobile telephone 100 to the SGSN 220.

At step 510, a reply message received from the first network element in response to the packet switched congestion status inquiry message is processed, wherein the reply message includes transmission delay information obtained from a device transmission delay between the first network element and the electronic device and a network transmission delay between the first network element and at least one packet switched support node in the wireless communication network. The transmission delay information can thus comprise a network elapsed time for a transmission between a gateway general packet radio service support node and a serving general packet radio service support node and a device elapsed time for a transmission between the serving general packet radio service support node and the electronic device. For example, in the wireless communication network 200, as shown at line 315 of FIG. 3, a reply message is sent from the SGSN 220 to the mobile telephone 100. The reply message includes transmission delay information obtained from a device transmission delay between the SGSN 220 and the mobile telephone 100, and a network transmission delay between the SGSN 220 and the GGSN 225.

At step 515, the packet switched congestion status of the wireless communication network is determined based on the transmission delay information. For example, in the wireless communication network 200, a packet switched congestion status, such as a “light”, “medium”, or “heavy” congestion status is determined based on a comparison of a total delay time between the mobile telephone 100 and the GGSN 225 with 1) benchmark delay times established by operators of the wireless communication network 200, or 2) observed average, maximum and minimum delay times.

Finally, at step 520, the packet switched congestion status is displayed on a display screen of the electronic device. For example, the congestion status is displayed on the display screen 105 of the mobile telephone 100 using one of the PS traffic status icons 405, 410, or 415.

Advantages of the present invention thus include enabling a user of an electronic device to be aware of a present packet switched congestion status of a wireless communication network to which the device is operatively connected. The user then can be better able to determine an expected quality of service concerning packet switched services, such as facsimile transmissions, data uploads and downloads, and internet access.

It will be appreciated that embodiments of the invention described herein may be comprised of one or more conventional processors and unique stored program instructions that control the one or more processors to implement, in conjunction with certain non-processor circuits, some, most, or all of the functions of displaying on an electronic device a packet switched congestion status of a wireless communication network as described herein. The non-processor circuits may include, but are not limited to, a radio receiver, a radio transmitter, signal drivers, clock circuits, power source circuits, and user input devices. As such, these functions may be interpreted as steps of a method of displaying on an electronic device a packet switched congestion status of a wireless communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims.

We claim:

1. A method for displaying on an electronic device a packet switched congestion status of a wireless communication network, the method comprising:
transmitting a packet switched congestion status inquiry message from the electronic device to a first network element in the wireless communication network;
processing a reply message received from the first network element in response to the packet switched congestion status inquiry message, wherein the reply message includes transmission delay information obtained from a device transmission delay between the first network element and the electronic device and a network transmission delay between the first network element and at least one packet switched support node in the wireless communication network;
determining the packet switched congestion status of the wireless communication network based on the transmission delay information; and
displaying the packet switched congestion status on a display screen of the electronic device.

2. The method of claim 1, wherein the transmission delay information comprises a network elapsed time for a transmission between a gateway general packet radio service support node and a serving general packet radio service support node and a device elapsed time for a transmission between the serving general packet radio service support node and the electronic device.

3. The method of claim 1, wherein the first network element is a serving general packet radio service support node.

4. The method of claim 1, wherein the at least one packet switched support node is a gateway general packet radio service support node.

5. The method of claim 1, wherein the first network element transmits sample packet data to the at least one packet switched support node.

6. The method of claim 1, wherein the packet switched congestion status concerns a general packet radio service congestion status.

7. The method of claim 1, wherein displaying the packet switched congestion status on the display screen of the electronic device uses a color-coded status icon.

8. The method of claim 1, wherein the congestion status inquiry message comprises only a single frame.

9. A mobile electronic device that displays a packet switched congestion status of a wireless communication network, the mobile electronic device comprising:
a display screen; and
a processor that is configured to convey a packet switched congestion status inquiry message to a first network element in the wireless communication network, process a reply message received from the first network element in response to the packet switched congestion status inquiry message, wherein the reply message includes transmission delay information obtained from a device transmission delay between the first network element and the mobile electronic device and a network transmission delay between the first network element and at least one packet switched support node in the wireless communication network, determine the packet switched congestion status of the wireless communication network based on the transmission delay information, and display the packet switched congestion status on the display screen.

10. The mobile electronic device of claim 9, wherein the packet switched congestion status concerns a general packet radio service congestion status.

11. The mobile electronic device of claim 9, wherein displaying the packet switched congestion status on the display screen of the electronic device uses a color-coded status icon.

12. The mobile electronic device of claim 9, wherein the congestion status inquiry message comprises only a single frame.

13. The mobile electronic device of claim 9, wherein the first network element is a serving general packet radio service support node.

14. The mobile electronic device of claim 9, wherein the at least one packet switched support node is a gateway general packet radio service support node.

15. A wireless communication system comprising the mobile electronic device of claim 9 and further comprising the first network element and the at least one packet switched support node, and wherein the first network element transmits sample packet data to the at least one packet switched support node.

16. The wireless communication system of claim 15, wherein the first network element is a serving general packet radio service support node, the at least one packet switched support node comprises a gateway general packet radio service support node, and wherein the transmission delay information comprises a network elapsed time for a transmission between the gateway general packet radio service support node and the serving general packet radio service support node and a device elapsed time for a transmission between the serving general packet radio service support node and the electronic device.
